(19) United States
(12) Patent Application Publication
(10) Pub. No.: US 2004/0151004 A1
(43) Pub. Date: Aug. 5, 2004

(54) Rear view mirror of vehicle having arrangeable and attachable light members

(76) Inventor: Jen Hsieh Shih, Chang Hua (TW)

Correspondence Address: Jen Hsieh Shih, P.O. Box 63-298, Taichung, 406, TW

(21) Appl. No.: 10/355,986

(22) Filed: Jan. 30, 2003

(51) Int. Cl. B60R 1/12

(52) U.S. Cl. 362/494

(57) ABSTRACT

A rear view mirror of vehicle includes a housing having a curved front surface, and a number of light members to be flexibly coupled together with electrical cables. The light members each may include a base arrangeably secured onto the curved front surface of the housing, and a circuit board having one or more light elements. The light members are separated individuals that may be easily secured onto the curved front surface of the housing and that may be easily arranged to various kinds of shapes or patterns. The light members each may include an upper convex cover to form a chamber between the cover and the base.

### BACKGROUND OF THE INVENTION

1. Field of the Invention

The present invention relates to a rear view mirror of vehicle, and more particularly to a rear view mirror of vehicle having arrangeable or attachable light members.

2. Description of the Prior Art

Various kinds of typical light devices or light members have been developed for attaching to planar portions of vehicles, in order to generate warning lights, particularly during the night, or in the dark environment.

U.S. Pat. No. 5,193,895 to Naruke et al., and U.S. Pat. No. 6,425,679 to Yu disclose two of the typical light devices or light members that may also be provided for attaching to planar portions of vehicles only, and may not be attached to the other curved portions of the vehicles.

For example, the rear view mirrors of vehicles comprise a curved front or outer surface, such that the typical light devices or light members may not be solidly attached or secured onto the curved front surface of the rear view mirrors of vehicles, and may be easily disengaged from the rear view mirrors of vehicles after use.

The typical light devices or light members, such as those disclosed in U.S. Pat. No. 5,193,895 to Naruke et al., and U.S. Pat. No. 6,425,679 to Yu may include a flexible structure for attaching to slightly curved portions of vehicles. However, the rear view mirrors of vehicles include a front surface having a great curvature to which the typical light devices or light members may not be solidly and firmly attached thereto.

The present invention has arisen to mitigate and/or obviate the afore-described disadvantages of the conventional rear view mirrors of vehicles.

### SUMMARY OF THE INVENTION

The primary objective of the present invention is to provide a rear view mirror of vehicle including a number of arrangeable or attachable light members for being easily attached or secured onto the curved front surfaces of the rear view mirrors of vehicles that have a great curvature, and for being easily arranged into various kinds of shapes or patterns.

In accordance with one aspect of the invention, there is provided a rear view mirror of vehicle comprising a rear view mirror housing including a curved front surface, a plurality of light members each including a base arrangeably secured onto the curved front surface of the rear view mirror housing, a plurality of circuit boards received in the light members respectively, and each including at least one light element disposed thereon, and a plurality of flexible and electrical cables coupled between the circuit boards, for coupling the light element of the circuit boards to electric power source of the vehicle, and to energize the light element of the circuit boards. The light members are separated from each other and are separated individuals and are flexibly coupled together with the flexible and electrical cables such that the light members may be easily secured onto the curved front surface of the housing of the rear view mirror of the vehicle, and may be easily arranged to various kinds of shapes or patterns.

The bases of the light members each includes an upper portion, and the light members each includes a cover secured onto the upper portion of the base, to form and define a chamber within and between the cover and the base.

The circuit boards each includes at least one terminal provided thereon and coupled to the flexible and electrical cables, for allowing the light elements of the light members to be electrically coupled together.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front elevational view of a vehicle including a rear view mirror in accordance with the present invention having a number of arrangeable or attachable light members attached or secured thereto;

FIG. 2 is an enlarged front elevational view of the rear view mirror of the vehicle;

FIG. 3 is an enlarged front elevational view of the rear view mirror of the vehicle similar to FIG. 2, illustrating the other arrangement of the light members onto the rear view mirror of vehicle;

FIG. 4 is a perspective view illustrating the light members for attaching to the rear view mirror of the vehicle;

FIG. 5 is a partial cross sectional view of the light members, taken along lines 5-5 of FIG. 4; and

FIGS. 6 and 7 are perspective views illustrating the other arrangements or the other outer contours of the light members of the rear view mirror.

### DETAILED DESCRIPTION OF THE PREFERRED EMBODIMENT

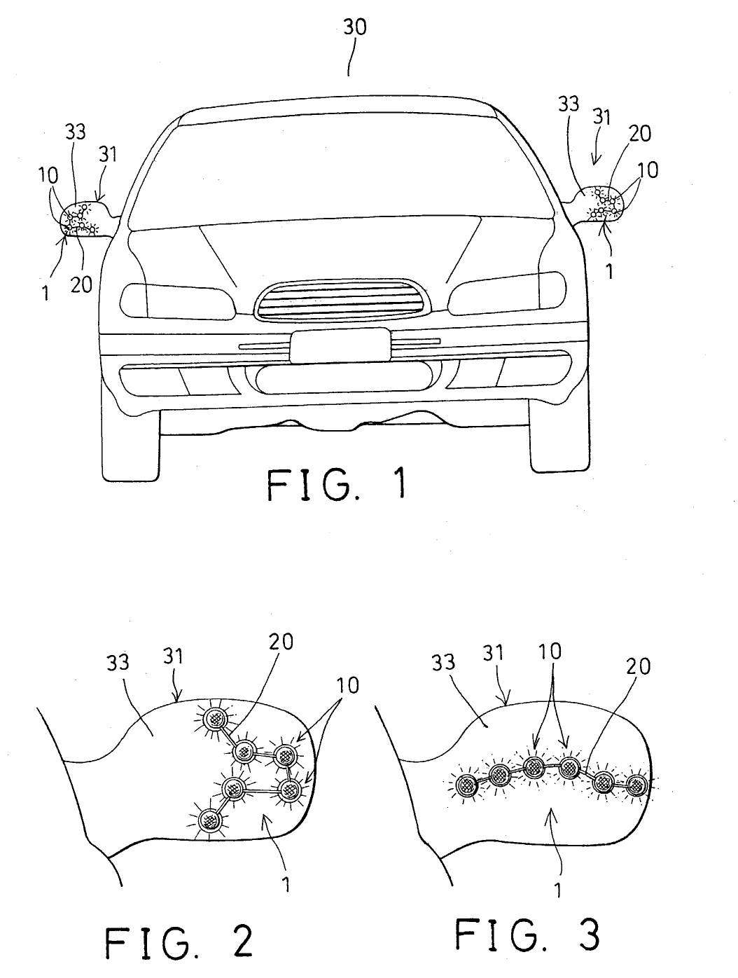

Referring to the drawings, and initially to FIGS. 1-5, a rear view mirror of a vehicle 30 in accordance with the present invention comprises a housing 31 including a curved front surface 33, and a light device 1 having a number of light members 10 to be arranged and secured onto the curved front surface 33 of the housing 31 of the rear view mirror of the vehicle 30.

The light members 10 of the light device 1 are separated from each other and are different or separated individuals and are flexibly coupled together with flexible and electrical wires or cables 20, such that the light members 10 of the light device 1 may be easily secured onto the curved front surface 33 of the housing 31 of the rear view mirror of the vehicle 30, and arrangeable to various kinds of shapes or patterns.

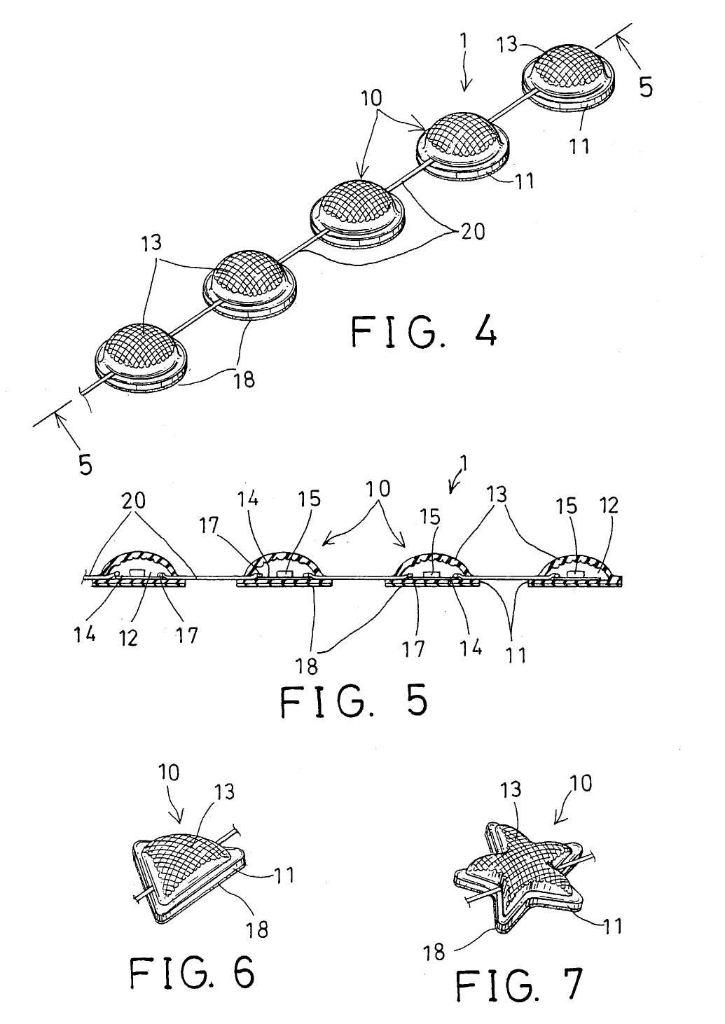

As shown in FIGS. 4 and 5, the light members 10 of the light device 1 each includes a planar base 11, and a curved and transparent or semi-transparent or convex cover 13 secured onto the upper portion of the planar base 11 by such as ultrasonic welding processes, in order to form or define a chamber 12 within or between the planar base 11 and the curved cover 13.

A circuit board 14 is engaged in the chamber 12 of each of the light members 10 of the light device 1, and preferably engaged with or contacted with the base 11, and includes one or more light elements 15, such as light emitting diodes, liquid crystal displays, illuminant materials, etc. secured thereon, for generating warning lights, for example.

The circuit boards 14 each may further include one or more conductors or terminals 17 provided thereon for electrically coupling to the flexible and electrical wires or cables 20, which may be coupled to the electric power source of the vehicle, for energizing the light members 10 of the light device 1.

The light members 10 of the light device 1 each may further include an adhesive layer or material 18 attached or applied onto the bottom surface of the base 11, for easily securing onto the curved front surface 33 of the housing 31 of the rear view mirror of the vehicle 30, and for allowing the light members 10 to be arranged to various kinds of shapes or patterns.

The light members 10 of the light device 1 may be shaped or arranged in the circular shape or outer contour as shown in FIGS. 1-4. As shown in FIGS. 6 and 7, the light members 10 of the light device 1 may also be shaped or arranged in the other shapes or outer contours, such as the triangular shape as shown in FIG. 6, or the star shape as shown in FIG. 7, or the other geometric shapes or contours or patterns.

It is preferable that the bases 11 and the covers 13 of the light members 10 of the light device 1 are made of flexible materials, for allowing the light members 10 of the light device 1 to be further easily and solidly secured onto the curved front surfaces of the rear view mirrors of vehicles.

Accordingly, the rear view mirror of vehicle in accordance with the present invention includes a number of arrangeable or attachable light members that may be easily attached or secured onto the curved front surfaces of the rear view mirrors of vehicles that have a great curvature, and that may be easily arranged into various kinds of shapes or patterns.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A rear view mirror of vehicle comprising:
a rear view mirror housing including a curved front surface,
a plurality of light members each including a base arrangeably secured onto said curved front surface of said rear view mirror housing,
a plurality of circuit boards received in said light members respectively, and each including at least one light element disposed thereon, and
a plurality of flexible and electrical cables coupled between said circuit boards, for coupling said at least one light element of said circuit boards to electric power source of the vehicle, and to energize said at least one light element of said circuit boards.

2. The rear view mirror of vehicle as claimed in claim 1, wherein said bases of said light members each includes an upper portion, and said light members each includes a cover secured onto said upper portion of said base, to form and define a chamber within and between said cover and said base.

3. The rear view mirror of vehicle as claimed in claim 1, wherein said circuit boards each includes at least one terminal provided thereon and coupled to said flexible and electrical cables.
